(19) United States
(12) Patent Application Publication
(10) Pub. No.: US 2026/0281829 A1
(43) Pub. Date: Sep. 17, 2026

(54) SHORTENING OF SERVICE INTERRUPTION TIME FOR LLM IN RAN4

(71) Applicant: Nokia Technologies Oy, Espoo (FI)

(72) Inventors: Xin ZHANG, Munich (DE); Lars DALSGAARD, Oulu (FI); Jani-Pekka KAINULAINEN, Cambridge (GB)

(21) Appl. No.: 19/199,228

(22) PCT Filed: Oct. 23, 2023
(86) PCT No.: PCT/EP2023/079494

§ 371 Date: May 5, 2025

(30) Foreign Application Priority Data
Nov. 14, 2022 (FI) 20226025

(51) Int. Cl. H04W 36/00

(52) U.S. Cl. CPC H04W 36/0058

(57) ABSTRACT

Described herein is a user equipment, UE, served by a source cell of a first network node that supports distributed unit, DU, functionality and/or a layer 2 protocol processing of a radio access network, RAN, the UE comprising: at least one processor, and at least one memory storing instructions that, when executed by the at least one processor, cause the UE at least to: generate L1 measurements for a plurality of candidate target cells controlled by the first network node, wherein said plurality of candidate target cells are selected based on L3 measurements generated by the UE; determine if said plurality of candidate target cells complies with one or more preset conditions for the UE to execute handover from said serving source cell to at least one of said plurality of candidate target cells for L1L2-triggered mobility, LTM; and transmit, preferably periodically, an L1 measurement report to the first network node, wherein said L1 measurement report is provided by the UE based on said determination relating to said one or more preset conditions, wherein said one or more preset conditions comprise: that Synchronization Signal/PBCH Blocks, SSBs, of said plurality of candidate target cells are detectable, and/or that a first timer has not expired since a first time point indicated by a first timestamp related to an L3 measurement report comprising said L3 measurements, and the UE is further caused to: at a second time point indicated by a second timestamp related to said L1 measurement report, determine if said first timer has expired, wherein said L3 measurement report is the latest L3 measurement report generated by the UE at the time of preparing said L1 measurement report.

### TECHNOLOGY

The present disclosure relates to L1L2-triggered mobility, LTM, in particular to interruption time in the LTM handover procedure.

### BACKGROUND

Any discussion of the background art throughout the specification should in no way be considered as an admission that such art is widely known or forms part of common general knowledge in the field.

Broadly speaking, for L1L2-triggered mobility (LTM), the UE reports L1 beam measurements to the serving DU (i.e., the source DU) and the serving source DU can decide when to trigger the handover to one or more candidate target cells which are indicated with the L1 measurement report provided by the UE based on that previous L3 measurement values provided by the UE have indicated that those one or more candidate target cells are determined as being suitable cells to which the UE can be handed over.

However, before the gNB makes a decision to trigger a cell change to said one or more candidate target cells, an indefinite amount of time may have already passed since the time when the UE indicated to the gNB those one or more candidate target cells. During this indefinite amount of time, previously known or detectable candidate target cells may not be detectable any more due to for instance mobility of the UE and etc. This leads to that, while the gNB relies on the received L1 measurement report indicating the “detecable” candidate target cells, those indicated cells are as a matter of fact not detectable any more, which the gNB is however not aware of.

Therefore, when the gNB, with the above lacking of knowledge in the actual detectability of the cells, triggers cell change for those cells that the gNB considers to be still detectable, the UE after receving the trigger message from the gNB may still have to carry out searching for those candidate target cells which are in fact not known any more. The time related to such a search, namely T-search (which is part of the interruption time in the LTM handover procedure), may be up to 60 ms. Only for those cells that are in fact still known to the UE, is the time related to search.

Therefore, it is necessary to resolve the above issue where the interruption time in the LTM handover procedure is indefinitely prolonged due to that, during the whole LTM handover procedure, neither the network nor the UE actively keeps track of the actual detectability of the candidate target cells for which the gNB triggers a cell change. In other words, it is necessary to propose methods and corresponding apparatuses for ensuring that for candidate target cells that are still known at the time of the gNB triggering a cell change, the T-search time is set to be 0, so as to reduce latency induced in the handover procedure, whereas for cell that are not any more known, it is necessary to provide a mechanism where at least the UE and the gNB are informed in particular of the possible delay induced.

### SUMMARY

In accordance with an aspect of the present disclosure, there is provided a user equipment, UE, served by a source cell of a first network node that supports distributed unit, DU, functionality and/or a layer 2 protocol processing of a radio access network, RAN, the UE comprising:
at least one processor; and
at least one memory storing instructions that, when executed by the at least one processor, cause the UE at least to:
   generate L1 measurements for a plurality of candidate target cells controlled by the first network node, wherein said plurality of candidate target cells are selected based on L3 measurements generated by the UE;
   determine if said plurality of candidate target cells complies with one or more preset conditions for the UE to execute handover from said serving source cell to at least one of said plurality of candidate target cells for L1L2-triggered mobility, LTM; and transmit, preferably periodically, an L1 measurement report to the first network node, wherein said L1 measurement report is provided by the UE based on said determination relating to said one or more preset conditions,
   wherein said one or more preset conditions comprise:
      that Synchronization Signal/PBCH Blocks, SSBs, of said plurality of candidate target cells are detectable, and/or
      that a first timer has not expired since a first time point indicated by a first timestamp related to an L3 measurement report comprising said L3 measurements, and the UE is further caused to: at a second time point indicated by a second timestamp related to said L1 measurement report, determine if said first timer has expired, wherein said L3 measurement report is the latest L3 measurement report generated by the UE at the time of preparing said L1 measurement report.

In some examples, said L1 measurement report comprises L1 measurements for one or more of said plurality of candidate target cells that are determined as complying with said one or more preset conditions.

In some examples, the UE is further caused to:
append an Invalid bit to said L1 measurement report for any one of said plurality of candidate target cells that is determined as not complying with said one or more preset conditions; and
transmit, preferably periodically, said L1 measurement report with said appended Invalid bit to the first network node.

In some examples, a length of said first timer is 5 seconds.

In some examples, the UE is further configured to determine whether SSBs of said plurality of candidate target cells are detectable based on at least one of: Synchronization Signal Reference Signal Received Power, SS-RSRP, CSI Reference Signal Received Power, CSI-RSRP, Synchronization Signal Reference Signal Received Quality, SS-RSRQ, CSI Reference Signal Received Quality, CSI-RSRQ, Synchronization Signal Signal to Interference and Noise Ratio, SS-SINR, CSI Signal to Interference and Noise Ratio, CSI-SINR.

In some examples, the UE is further caused to:
after receiving from the first network node a cell change trigger message, transmit a cell change trigger response message to the first network node if it is determined that any one of said plurality of candidate target cells that is determined as not complying with said one or more preset conditions.

In some examples, the UE is further caused to:
in said cell change trigger response message, include T-Search information indicating a first estimated time required for searching any one of said plurality of candidate target cells that is determined as not complying with said one or more preset conditions.

In some examples, the UE is further caused to:
in said cell change trigger response message, include T-IU information indicating a second estimated time for Interruption Uncertainty in acquiring the first available Physical Random Access Channel, PRACH, occasion in any one of said plurality of candidate target cells that is determined as not complying with said one or more preset conditions, wherein preferably said second estimated time is determined based on whether a Random Access Channel, RACH or RACH-less procedure is applied by the UE.

In some examples, said cell change trigger response message is transmitted via lower layer signaling.

In accordance with another aspect of the present disclosure, there is provided a first network node, being configured to support distributed unit, DU, functionality and/or a layer 2 protocol processing of a radio access network, RAN, said first network node comprising:
at least one processor; and
at least one memory storing instructions that, when executed by the at least one processor,
cause the first network node at least to:
   determine if a plurality of candidate target cells controlled by the first network node complies with one or more preset conditions for a UE to execute handover from a serving source cell of the first network node to at least one of said plurality of candidate target cells for L1L2-triggered mobility, LTM, wherein said determination is carried out by the first network node based on L1 measurements and/or L3 measurements provided by the UE for said plurality of candidate target cells; and
   transmit a cell change trigger message to the UE based on said determination, wherein said cell change trigger message comprises indications for triggering change to one or more of said candidate target cells that are determined as complying with said one or more preset conditions.

In some examples, the first network node is further configured to:
for each of said one or more candidate target cells, determine whether said each candidate target cell complies with said one or more preset conditions, wherein said one or more preset conditions comprise that, for said each candidate target cell, an L1 measurement report comprising said L1 measurements received from the UE does not comprise an Invalid bit

In some examples, the first network node is further configured to: for each of said one or more candidate target cells, determine whether said each candidate target cell complies with said one or more preset conditions, wherein said one or more preset conditions comprise that, for said each candidate target cell, a second timer has not expired since a first time point indicated by a first timestamp related to an L3 measurement report comprising said L3 measurements received from the UE, wherein the first network node is further caused to:
at a third time point, determine if said second timer has expired, wherein said third time point is after receiving from the UE an L1 measurement report comprising said L1 measurements and before transmitting said cell change trigger message to the UE, wherein said L3 measurement report is the latest L3 measurement report generated by the UE at the time of preparing said L1 measure report.

In some examples, the first network node is further caused to transmit said cell change trigger message before said second timer expires.

In some examples, a length of said second timer is 5 seconds.

In some examples, the first network node is further caused to: include a failure indication in said cell change trigger message for any one of said plurality of candidate target cells that is determined as not complying with said one or more preset conditions.

In some examples, said cell change trigger message is transmitted via lower layer signaling, and is preferably MAC Control Element, MAC CE, or Downlink Control Information, DCI.

In accordance with another aspect of the present disclosure, there is provided a second network node, being configured to support central unit, CU, functionality and/or a layer 3 protocol of a radio access network, RAN, comprising:
at least one processor; and
at least one memory storing instructions that, when executed by the at least one processor, cause the second network node at least to:
determine a first timestamp related to an L3 measurement report that is received from a UE, said UE being served by a source cell of a first network node, said L3 measurement report comprises L3 measurements for a plurality of candidate target cells controlled by said first network node;
include said first timestamp in CU to DU RRC Information to be transmitted to said first network node; and
transmit said CU to DU RRC Information with included first timestamp to said first network node.

In some examples, the second network node is further caused to transmit said CU to DU RRC Information in a UE context modification request message.

In some examples, the second network node is further caused to: before a third timer expires, decide to perform preparation of said plurality of candidate target cells for the UE to execute handover from said serving source cell to at least one of said plurality of candidate target cells for L1L2-triggered mobility, LTM, wherein said third timer starts at a fourth time point of receiving said L3 measurement report from the UE.

In some examples, said performing preparation of said plurality of candidate target cells comprises one or more of: transmitting a UE context setup request message to said first network node, generating and transmitting to said first network node RRC reconfigurations related to said plurality of candidate target cells, and transmitting a UE context modification request message to said first network node.

In some examples, a length of said third timer is 5 seconds.

In accordance with another aspect of the present disclosure, there is provided a method of a user equipment, UE, served by a source cell of a first network node that supports distributed unit, DU, functionality and/or a layer 2 protocol processing of a radio access network, the method comprising:
generating L1 measurements for a plurality of candidate target cells controlled by the first network node, wherein said plurality of candidate target cells are selected based on L3 measurements generated by the UE;
determining if said plurality of candidate target cells complies with one or more preset conditions for the UE to execute handover from said serving source cell to at least one of said plurality of candidate target cells for L1L2-triggered mobility, LTM; and transmitting, preferably periodically, an L1 measurement report to the first network node, wherein said L1 measurement report is provided by the UE based on said determination relating to said one or more preset conditions,
wherein said one or more preset conditions comprise:
   that Synchronization Signal/PBCH Blocks, SSBs, of said plurality of candidate target cells are detectable, and/or
   that a first timer has not expired since a first time point indicated by a first timestamp related to an L3 measurement report comprising said L3 measurements, wherein the method further comprises: at a second time point indicated by a second timestamp related to said L1 measurement report, determining if said first timer has expired, wherein said L3 measurement report is the latest L3 measurement report generated by the UE at the time of preparing said L1 measurement report.

In accordance with another aspect of the present disclosure, there is provided a method of a first network node being configured to support distributed unit, DU, functionality and/or a layer 2 protocol processing of a radio access network, the method comprising:
determining if a plurality of candidate target cells controlled by the first network node complies with one or more preset conditions for a UE to execute handover from a serving source cell of the first network node to at least one of said plurality of candidate target cells for L1L2-triggered mobility, LTM, wherein said determination is carried out by the first network node based on L1 measurements and/or L3 measurements provided by the UE for said plurality of candidate target cells; and
transmitting a cell change trigger message to the UE based on said determination, wherein said cell change trigger message comprises indications for triggering change to one or more of said candidate target cells that are determined as complying with said one or more preset conditions.

In accordance with another aspect of the present disclosure, there is provided a method of a second network node being configured to support central unit, CU, functionality and/or a layer 3 protocol of a radio access network, RAN, the method comprising:
determining a first timestamp related to an L3 measurement report that is received from a UE, said UE being served by a source cell of a first network node, said L3 measurement report comprises L3 measurements for a plurality of candidate target cells controlled by said first network node;
including said first timestamp in CU to DU RRC Information to be transmitted to said first network node; and
transmitting said CU to DU RRC Information with included first timestamp to said first network node.

In accordance with another aspect of the present disclosure, there is provided a user equipment, UE, configured to connect to a source cell of a first network node that supports distributed unit, DU, functionality and/or a layer 2 protocol processing of a radio access network, RAN, the UE comprising:
at least one processor; and
at least one memory storing instructions that, when executed by the at least one processor, cause the UE at least to:
   generate a L1 measurement for at least one candidate target cell for potential L1L2-triggered mobility, LTM;
   determine if at least one of said at least one candidate target cells complies with one or more preset conditions for the UE; and
   generate and transmit a L1 measurement report to the first network node, wherein said L1 measurement report is provided by the UE based on said determination relating to said one or more preset conditions,
      wherein said one or more preset conditions comprise:
         that a first timer has not expired associated with a first time point related to a corresponding L3 measurement, and
         the UE is further caused to: determine a timing offset till expiry of the first timer, and to include an indication associated with the determined timing offset in the L1 measurement report.

It might be advantageous to calculate the timing offset in the UE and provide this information to the DU. This way, the DU is informed how much time is still available till the repoted candidate cell is considered to be known in the UE and thus Tsearch will be zero, and thus handover can be performed quickly, without further delay. The DU bases his decision to handover typically on one or more criteria or parameter, one of them could be the time left till expiry of the first timer, another, e.g. the load conditions in the DU or the DU the UE could switch to.

In some examples, the indication associated with the determined timing offset is included in the L1 measurement report to enable the first network node to decide upon handover to one of the candidate cells in the L1 report before the first timer expires.

In some examples, the indication may include an absolute value of the time remaining till the first timer expires.

In accordance with another aspect of the present disclosure, there is provided a first network node, configured to support distributed unit, DU, functionality and/or a layer 2 protocol processing of a radio access network, RAN, said first network node comprising:
at least one processor; and
at least one memory storing instructions that, when executed by the at least one processor, cause the first network node at least to:
   receive a L1 measurement report, from a user equipment connected to a source cell supported by the first network node, for at least one candidate target cell for potential L1L2-triggered mobility, LTM,
   determine if a handover from the source cell of the first network node to a candidate cell shall be triggered; and
   transmit a cell change trigger message to the UE based on said determination, wherein said determination is based on one or more preset conditions, wherein one condition includes whether a first timer has not expired associated with a first time point related to a corresponding L3 measurement.

It might be advantageous to calculate the timing offset in the UE and provide this information ot the DU. This way, the DU is informed how much time is still available till the repoted candidate cell is considered to be known in the UE and thus Tsearch will be zero, and thus handover can be performed quickly, without further delay. The DU bases his decision to handover typically on one or more criteria or parameter, one of them could be the time left till expiry of the first timer, another, e.g. the load conditions in the DU or the DU the UE culd switch to. Instead of a timing offset the first time point related to a corresponding L3 measurement can be transmitted to DU, this way the DU is enabled to calculate on its own the time left till expiry and decide taking this into account. The timing information might be transmitted ot the DU by the UE or the CU. In order to decrease the amount of signaling the timing information might be transmitted e.g. together with a L1 measurement report or the configuration of the DU for LTM. The DU might be instructed by the CU to decide within the indicated time limit, e.g. before expiry of the timer, in order to enable handover with low delay, e.g. Tsearch=zero. Or, the DU might be instructed by the CU to decide within the indicated time limit if possible, e.g. in case such decision would not jeopardize other decisions. The forwarding of the timing information could be optional, and/or its use optional. The DU might be configured to use provided timing info or not. If beneficial to the DU, the DU may decide to trigger handover before the indicated timer expired, but may also decide to trigger handver after the timer already expired. In the latter case the DU knows that the UE will have Tsearch not equal to zero and potentially takes appropriate actions on the network side. The calculation of the timer expiry may include the calculation of the time the trigger needs to be generated and transmitted to the UE, and potentially also the time the UE takes to process the trigger message and execute the handover. This way the Du projects the tie the UE will need till execution of handover, e.g. sending random access message to new DU, and takes this time into account to select the time to trigger handover such that the UE still knows the indicated target candidate cell when executing handover.

In some examples the indication related to the first time point is received from the user equipment or a second network node, configured to support central unit, CU, functionality and/or a layer 3 protocol of a radio access network, RAN, before the determination.

In some examples the indication associated with the determined timing offset is included in the L1 measurement report to enable the first network node to decide upon handover to one of the candidate cells in the L1 report before the first timer expires.

In some examples the indication may include an absolute value of the time remaining till the first timer expires.

In some examples the L1 measurement report includes an indication associated with a timing offset till expiry of a first timer associated with a first time point related to a corresponding L3 measurement of said at least one candidate cell; and decide upon handover to one of said at least one candidate cell in the L1 report before the first timer expires.

In accordance with another aspect of the present disclosure, there is provided a second network node, configured to support central unit, CU, functionality and/or a layer 3 protocol of a radio access network, RAN, comprising:
at least one processor; and
at least one memory storing instructions that, when executed by the at least one processor, cause the second network node at least to:
   determine a first timestamp related to an L3 measurement report that is received from a UE, said UE being served by a source cell of a first network node, said L3 measurement report comprises L3 measurements for at least one candidate target cells for handover; include an indication related to said first timestamp in a message to be transmitted to said first network node; and transmit said message with included first timestamp related indication to said first network node.

In some examples the message is a message configuring the first network node to trigger potential L1L2-triggered mobility, LTM, and to receive L1 measurement reports from the user equipment.

In some examples the indication may include an absolute value of the time remaining till the first timer expires.

In accordance with another aspect of the present disclosure, there is provided a user equipment, UE, configured to connect to a source cell of a first network node that supports distributed unit, DU, functionality and/or a layer 2 protocol processing of a radio access network, RAN, the UE comprising:
at least one processor; and
at least one memory storing instructions that, when executed by the at least one processor, cause the UE at least to:
   generate a L1 measurement for at least one candidate target cell for potential L1L2-triggered mobility, LTM;
   determine if at least one of said at least one candidate target cells complies with one or more preset conditions for the UE; and
   generate and transmit a L1 measurement report to the first network node, wherein said L1 measurement report is provided by the UE based on said determination relating to said one or more preset conditions,
   wherein said one or more preset conditions comprise:
      that a first timer has not expired associated with a first time point related to a corresponding L3 measurement, and
      the UE is further caused to: transmit a timing indication to the first network node, wherein the timing indication is associated with the first time point related to the corresponding L3 measurement.

In some examples the indication may include an absolute value of the time remaining till the first timer expires, or a time stamp of the first time point.

According to some example embodiments, there is also provided a computer program comprising instructions for causing an apparatus to perform the method as disclosed in the present disclosure.

According to some example embodiments, there is also provided a memory storing computer readable instructions for causing an apparatus to perform the method as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of RAN2 Timing diagram;

FIG. 2 schematically illustrates an example of LTM cases in rel-18 with inter-CU, intra-CU and inter-DU cell switches;

FIG. 3 schematically illustrates an example of a signalling diagram of LTM behavior, illustrating T_search;

FIG. 4 schematically illustrates an example of LTM interruption time;

FIG. 5 schematically illustrates an example of LTM interruption time in RACH-LESS and RACH cases, illustrating T_IU;

FIG. 6 schematically illustrates an example of validity check at the CU and the UE in an LTM procedure; and

FIG. 7 schematically illustrates an example of validity check at the CU, the source DU and the UE in an LTM procedure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1

### INCORPORATED BY REFERENCE

Different functional splits between the central and distributed unit are possible, e.g., called options:

### Option 1 (1A-Like Split):

The function split in this option is similar to the 1A architecture in DC. RRC is in the central unit. PDCP, RLC, MAC, physical layer and RF are in the distributed unit.

### Option 2 (3C-Like Split):

The function split in this option is similar to the 3C architecture in DC. RRC and PDCP are in the central unit. RLC, MAC, physical layer and RF are in the distributed unit.

### Option 3 (Intra RLC Split):

Low RLC (partial function of RLC), MAC, physical layer and RF are in the distributed unit. PDCP and high RLC (the other partial function of RLC) are in the central unit.

### Option 4 (RLC-MAC Split):

MAC, physical layer and RF are in the distributed unit. PDCP and RLC are in the central unit.

Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may be omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

References are now made to the figures. In particular, it is to be noted that identical or like reference numbers used in the figures of the present disclosure may, unless indicated otherwise, indicate identical or like elements, such that repeated description thereof may be omitted for reasons of conciseness. It is further to be noted that, as can be understood and appreciated by the skilled person, even though the figures may appear to make reference to some specific/explicit message names/types, these messages may certainly, depending on various implementations (e.g., the underlining technologies), have different names and/or be communicated/exchanged in different forms/formats.

3GPP RAN groups are discussing about L1L2-Triggered Mobility (LTM). RAN Plenary has set the following objects for this work, according to 3GPP RP-221799. Namely to specify mechanism and procedures of L1/L2 based inter-cell mobility for mobility latency reduction: Configuration and maintenance for multiple candidate cells to allow fast application of configurations for candidate cells [RAN2, RAN3]; Dynamic switch mechanism among candidate serving cells (including SpCell and SCell) for the potential applicable scenarios based on L1/L2 signalling [RAN2, RAN1]; L1 enhancements for inter-cell beam management, including L1 measurement and reporting, and beam indication [RAN1, RAN2] (Note 1: Early RAN2 involvement is necessary, including the possibility of further clarifying the interaction between this bullet with the previous bullet); Timing Advance management [RAN1, RAN2]; and CU-DU interface signaling to support L1/L2 mobility, if needed [RAN3]. Note 2: FR2 specific enhancements are not precluded, if any. Note 3: The procedure of L1/L2 based inter-cell mobility are applicable to the following scenarios: Standalone, CA and NR-DC case with serving cell change within one CG; Intra-DU case and intra-CU inter-DU case (applicable for Standalone and CA: no new RAN interfaces are expected); Both intra-frequency and inter-frequency; Both FR1 and FR2. Source and target cells may be synchronized or non-synchronized.

The main goal of this work is to reduce the handover latency in the scenarios described above.

In general, for L1L2 Triggered Mobility (LTM) it is expected that the UE reports L1 beam measurements to the serving DU and as such the serving DU can decide when to trigger the handover. The purpose of this is to simplify many of the network and UE mobility procedures as well as reduce the interruption time/delay caused by the mobility. Furthermore, network data forwarding, scheduling are expected to also benefit from LTM. In the LTM, UE may maintain configuration of multiple cells to apply the fast application of each configuration.

The LTM may involve serving cell change or not, and it can use either RACH or be RACH-less.

In LTM, the serving DU triggers the execution of the prepared target cell configuration based on lower layer signaling, which can be either MAC Control Element (MAC CE) or Downlink Control Information (DCI). Upon triggering the cell change, the serving DU informs the CU such that the CU can stop sending any RRC Reconfiguration over the serving cell radio link and initiate data forwarding to the target cell, if needed.

LTM is expected to use L1 measurements. These measurements have the benefit of faster reaction time to radio link degradation in the serving link as the network can save the delay introduced by L3 filtering and Time to Trigger (TTT) for the handover decision. This should result in reducing in the number of radio link failures compared to baseline handover.

Reference is made to 3GPP R4-2219443, R4-2219444, R4-2219445, R4-2219446 for further discussions relating to the LTM topic.

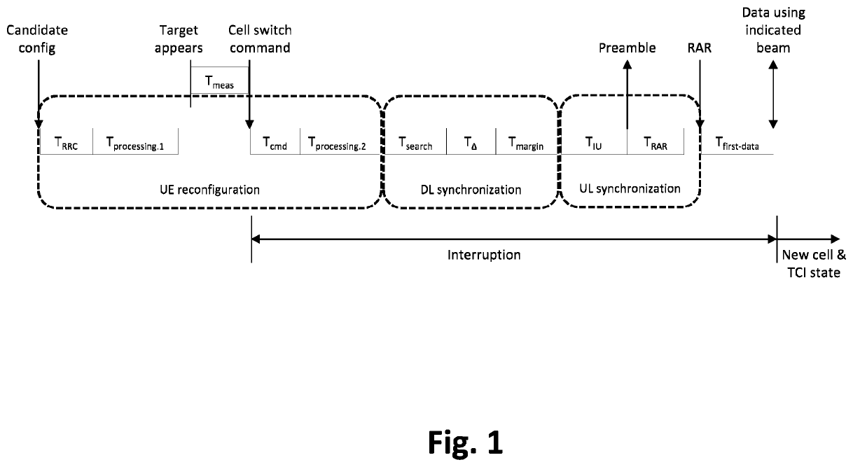

In a recent RAN2 discussion, it has agreed that the handover (HO) interruption time for LTM is defined as the time from UE receiving the cell switch command to UE performing the first DL/UL reception/transmission on the indicated beam of the target cell. The timing diagram in FIG. 1 shows the components that contribute to the HO interruption for LTM.

The meaning of each component is illustrated in the Table 1 below further:

TABLE 1
Explanation of each component in LLM HO service interruption time

| | | RAN2 | Expected |
|---|---|---|---|
| Time | | discussed | value for |
| association | Description | Value | LLM |
| T_{RRC} | Processing time for RRCReconfiguration | Up to [10] ms | FFS |
| | carrying candidate configurations | | |
| T_{processing}_{_{—}}_{1/2} | Time for UE processing, before and after cell | Up to [20] ms | FFS |
| | switch command, respectively. This may | for same FR | |
| | include L2/3 reconfiguration, RF retuning, | Up to [40] ms | |
| | baseband retuning, security update if needed, | for different | |
| | etc. | FR | |
| Tₘₑₐₛ | Measurement delay (from target appears to | | FFS |
| | cell switch command) | | |
| T_cmd | Time for processing L1/L2-command (HARQ | Up to [5] ms | |
| | and parsing) | | |
| T_{search} | Time required to search the target cell | 0 ms (if cell | FFS |
| | | is known) | |
| | | Up to [60] ms | |
| | | (if cell is | |
| | | unknown) | |
| T_{Δ} | TΔ is time for fine time tracking and acquiring | SMTC | FFS |
| | full timing information of the target cell. | periodicity | |
| | | (typ. [20] ms) | |
| T_{margin} | T_{margin} is the time for SSB post-processing and | Up to [2] ms | FFS |
| | can be up to 2 ms. | | |
| T_{IU} | T_{IU} is the interruption uncertainty in acquiring | Typ. [15] ms | FFS |
| | the first available PRACH occasion in the new | | |
| | cell. In addition, there are the interruptions of | | |
| | sending PRACH preamble and receiving the | | |
| | RACH response (RAR). | | |
| T_{RAR} | Time for RAR delay | Typ. [4] ms | FFS |
| T_{_{—}}_{first-data} | Time for UE performs the first DL/UL | | FFS |
| | reception/ transmission on the indicated | | |
| | beam of the target cell, after RAR | | |

RAN4 has been discussing about T_search (Time required to search the target cell), the following summarises the RAN2 agreements and the current status.

RAN2 Agreements: R2 assumes that the following items may be discussed by RAN1 and RAN4 (and may be scenario specific):—Whether to perform DL synchronization to candidate/target cell before receiving the cell switch command. R2 assumes this is feasible at least for the case that the target cell is already an active serving cell;—Whether to support of performing TRS tracking and CSI measurement of candidate/target cell before/by cell switch command.

T_search as indicated above refers to the time requires to search for the target cell. After the MAC-CE cell switch trigger from DU is sent to UE, the following condition is specified in current 3GPP for the value of Tsearch: 0 ms if the cell is known; up to 60 ms if the cell is not known.

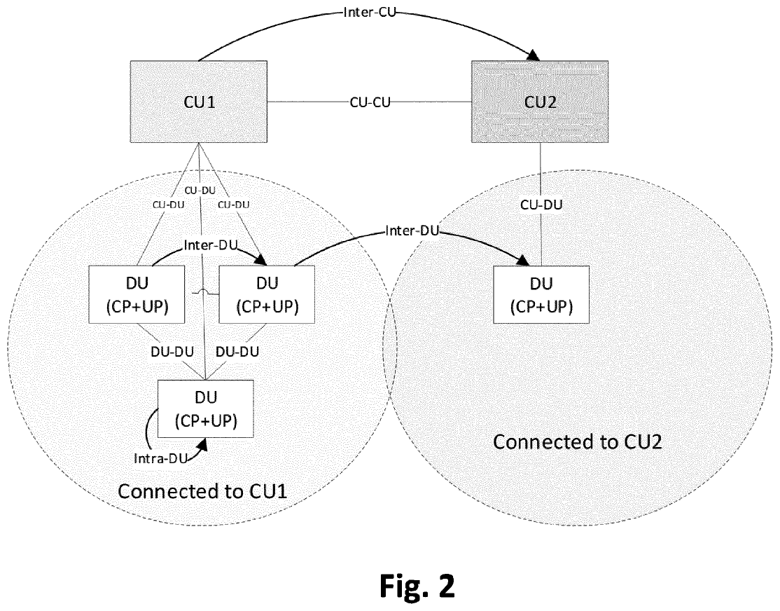

To illustrate the different LTM scenarios, FIG. 2 shows the difference between inter-CU (L3 Handover) and intra-CU, inter-DU cell switches. The release-18 work focuses initially on intra- and inter-DU cases. The scope can be extended further in the future releases.

According to for instance NR38.133, V17.6.0, “Technical Specification Group Radio Access Network; NR; Requirements for support of radio resource management”, section 9.13.2, the known condition of a cell in 3GPP is defined as follows, namely that the cell with different Physical Cell ID (PCI) from serving cell is considered as known if the following conditions are met in this requirement:
The SSB of the cell with different PCI from serving cell has the same SCS and center frequency as the SSB of the PCell;
The timing difference of arrival at UE between the SSBs of serving cell and cell with different PCI is less than CP length of the corresponding SCS;
The UE has sent a valid L3 measurement report during the last 5 seconds; and
The SSB from the cell with different PCI remains detectable according to the cell identification requirements specified in clause 9.2.
Otherwise, the cell is unknown.

The above conditions are defined from UE perspective and with reference to Synchronization Signal/PBCH Block (SSB).

The first condition states that “The SSB of the cell with different PCI from serving cell has the same SCS and center frequency as the SSB of the PCell”. This is the definition that RAN4 has agreed in the last meeting for intra-frequency measurement. From the tdoc reviews from the current meeting, there is a trend that inter-frequency measurements are considered in LTM. As a result, the above known condition would have to be revised for LTM case.

The second condition states that “The timing difference of arrival at UE between the SSBs of serving cell and cell with different PCI is less than CP length of the corresponding SCS”. This is the definition for synchronised or asynchronized transmission. It is also being discussed if this concept shall be adopted in the case of LTM.

The last two criteria are not definition related, and straight forward as measurements report or values are obvious to see. Hence, these two criteria are discussed in the present disclosure.

The detectability of the SSB as defined in NR 38.133, Clause 9.2/9.3 is that “The UE shall be able to identify new intra/inter-frequency cells and perform SS-RSRP, SS-RSRQ, and SS-SINR measurements of identified intra/inter-frequency cells if carrier frequency information is provided by PCell or the PSCell, even if no explicit neighbour list with physical layer cell identities is provided.”

An intra/inter-frequency cell shall be considered detectable when for each relevant SSB:
SS-RSRP related side conditions given in NR38.133, clauses 10.1.4 and 10.1.5 for FR1 and FR2, respectively, for a corresponding Band,
SS-RSRQ related side conditions given in NR38.133, clauses 10.1.9 and 10.1.10 for FR1 and FR2, respectively, for a corresponding Band,
SS-SINR related side conditions given in NR38.133, clauses 10.1.14 and 10.1.15 for FR1 and FR2, respectively, for a corresponding Band,
SSB_RP and SSB Ês/Iot according to NR38.133, Annex B.2.3 for a corresponding Band.

As explained above, the candidate cell RRC configurations are prepared by the CU based on L3 measurements. UE does the L1 measurements for the candidate cells, and DU triggered the serving cell change based on those L1 measurements. One problem arises here would be due to the difference between L1 and L3 measurements. The term “L3 measurement” implies that L3 does filtering on the L1 values and does the final reporting. Filtering is done to remove the effect of fast fading and ignore short-term variations. Though L1 may collect measurements more often, L3 might report them at a larger configured periodicity. Thus, L3 takes a longer-term view of channel conditions. The maximum L3 measurement reports can go up to 30 minutes.

Secondly, there is no timer specified in RAN2 for when DU has to make the decision for serving cell change. It could happen that due to movement, the cell that the UE once knows for L3 measurement, is not known to UE anymore, given also the fact that L3 measurement report can be configured with a much longer periodicity.

Hence, in the present disclosure, it is investigated that in the context of LTM, what condition shall be configured in order to guarantee that Tsearch is zero, or alternative, what method can be implemented such that network knows if UE has known the cell before for instance, 5 seconds timer expired. Of course, the 5 seconds time is merely used herein as an example value for explanation purposes, which shall not be construed as being limiting on the scope of the present disclosure.

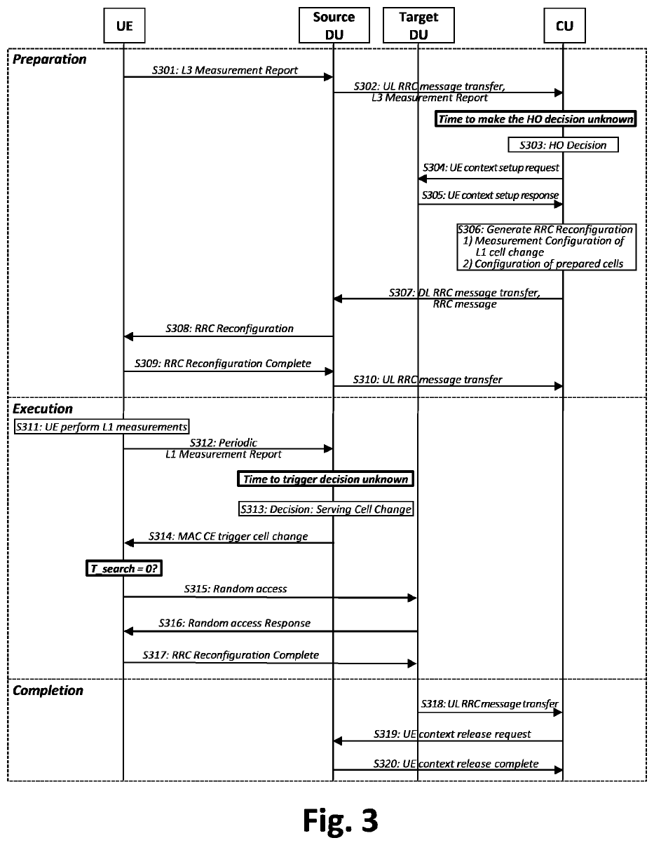

To facilitate the understanding of the problem, FIG. 3 shows an example of a signalling diagram of LTM behavior, illustrating T_search.

It is noted that in the present disclosure, with the terms “candidate cell”, “candidate target cell”, and “target cell”, it is referred to cells that are detected by the UE based on the L3 measurements of the serving source cell and neighbouring cells and are accordingly determined and selected from said serving source cell and neighbouring cells by the UE as being suitable for performing handover from the serving source cell.

Further, it is noted that in the present disclosure, with the term “known condition(s)” or “detectability condition(s)” of a (candidate target) cell it is referred to one or more conditions as defined in 3GPP for said cell to be considered as being detecbtable at the UE. For instance, complying with said conditions at the time of the UE excecuting a cell change leads to that the UE does not have to search said (candidate target) cell, namely that the interruption time T search is 0.

In the following, with reference being made to FIG. 3, it is highlighted 5 cases that the candidate cells prepared by CU could be unknown to UE or gNB, such that T_search will not be guaranteed to be zero, leading to increased interruption time in LTM HO service. In this example, it is assumed that cell 1, cell 2, cell 3 (based on L3 measurements) are detected by the UE as candidate target cells for performing HO.

As shown in FIG. 3, the UE is connected to source DU. Further, the UE performs L3 measurements and detects cell 1, cell 2, cell 3 (not shown in FIG. 3).

At steps S301-S302: the UE reports cells 1-3 to the CU. It is noted that up to this point, cells 1-3 are always known to the network.

At step S303: the CU decides to configure L1 measurements. It is noted that up to this point, cells1-3 are not always known to the network. The reason is that it is indefinite how fast the gNB acts on the L3 measurement report received from the UE. This indefinite reaction scenario at the CU is referred to as Case 1 in the present disclosure.

At steps S304-S310: the CU instructs the UE to perform L1 measurements for cells 1-3. It is noted that up to this point, cells 1-3 are not always known. The reason is long periodicity of L3 measurement report as explained above. Cells 1-3 may become not known to the UE already during the long periodicity of the L3 measurement report, but the gNB doesn't know that the cells 1-3 have become not known in the course of the long periodicity of the L3 measurement report, because all that the gNB has is just the previous L3 reports received from the UE. As mentioned above, the maximum L3 measurement reports can be configured to have as long as a 30 min periodicity.

At step S311, it is identified according to the present disclosure that there may be two cases, S311a and S311b (not shown in FIG. 3).

At step S311a: the UE performs L1 measurements and still detects cell 1, cell 2, but for instance cell 3 no more, or there is at least one detectable cell. This scenario, where the UE, at the time of performing L1 measurements, still detects at least one of the candidate target cells that are previously detected based on L3 measurements, is referred to as Case 2 in the present disclosure.

At step S311b: the UE performs L1 measurements and detects no more cell 1, cell 2, cell 3. This scenario, where the UE, at the time of performing L1 measurements, detects none of the candidate target cells that are previously detected based on L3 measurements, is referred to as Case 3 in the present disclosure.

However, it is not provided in the prior art a discussion of the above Case 2 and Case 3 which may occur due to the long periodicity of the L3 measurements. As a result, the gNB is not informed of such possible changes in the detectability of the candidate target cells, that is, changes in whether the candidate target cells (identified by the L3 measurements) still comply with the known conditions at the time of the UE performing L1 measurements.

At step S312: the UE reports, preferably periodically, the L1 measurements to the gNB.

At step S313: the DU decides to trigger handover for e.g., cells 1 and 2. It is noted that at this point, cell 1, cell 2 (which according to the example of Case 2 above are known at the time of L1 measurements) may also become unknown if the timer of for instance 5 seconds expires even if they were known at step S312 or earlier, or with the new L3 measurement report. This scenario, where, at the time of the gNB deciding to trigger handover to one of the candidate target cells, said one candidate targt cell however has already become unknown due to that a certain period of time has expired since the time point at which for instance the gNB receives from the UE the L1 measurement report, is referred to as Case 4 in the present disclosure.

At step S314: the DU sends trigger for cell change to the UE. It is noted that, for the gNB, it may be that as discussed with the above Case 4, a candidate target cell becomes unknown since a certain period of time has expired in which for instance the UE has moved, leading to that said candidate target cell becomes not detectable. In this case, the T_search time would be up to for instance 60 ms. That is, the T_search time is not 0 for this now unknown candidate target cell. In this example, it is assumed that cell 2 becomes unknown. This scenario where the UE has to search the candidate target cell is referred to as Case 5 in the present disclosure.

At steps S315-S320: the UE performs handover to e.g., known cell 1 and with Tsearch for cell 1 being zero. Since cell 3 has become unknown as explained at step S311, and cell 2 has become unknown as explained at steps S313 and S314, only cell 1 is known at the time of the gNB deciding to trigger handover. As a result, the T_search time for cell 1 is 0 and the UE does not have search cell 1 while excecuting cell change, whereas the UE would have to search cells 2 and 3 since they are in fact not known any more at the UE.

With the issues identified with the above 5 cases, it is proposed the following methods by the present disclosure.

In the latest published NR 38.133, the following L3 handover service interruption time is defined. The service interruption time for L3 handover is defined as the time between end of the last TTI containing the RRC command on the old PDSCH and the time the UE starts transmission of the new PRACH, excluding the RRC procedure delay. It is represented by the following equation:

$$T\_interrupt = T\_search + T\_IU + T\_processing + T\_Δ + T\_margin ms$$

The explanation of each component in the above equation is illustrated in the following table:

TABLE 2
Explanation of each component in L3 HO service interruption time

| Time | |
|---|---|
| association | Description |
| T_{processing} | T_{processing} is the time for UE processing. |
| T_{IU} | T_{IU} is the interruption uncertainty in acquiring |
| | the first available PRACH occasion in the new cell |
| T_{search} | T_{search} is the time required to search the target cell, |
| | depending on if the target cell is known/unknown |
| T_{Δ} | T_{Δ} is time for fine time tracking and acquiring |
| | full timing information of the target cell. |
| T_{margin} | T_{margin} is the time for SSB post-processing and |
| | can be up to 2 ms. |

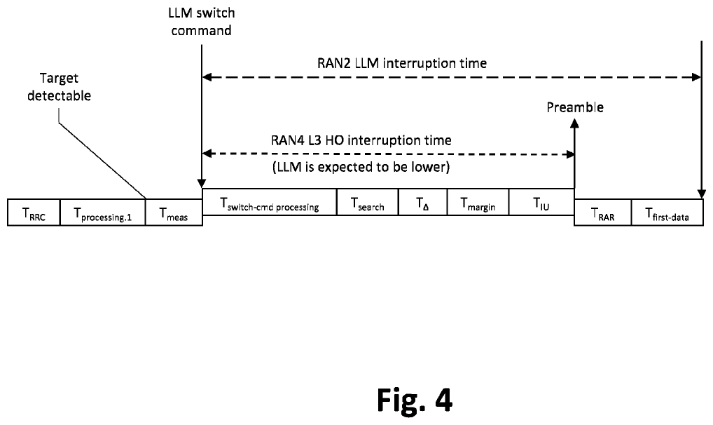

FIG. 4 illustrate the definition of service interruption time from RAN2 and RAN4 perspective. In RAN2, the UL sync could be RACH-less. In this case, the end of the interruption time could be as early as the first UL/DL data transmission before RACH.

In order to shorten the service interruption time, the methods are provided by the present disclosure that can set T_search to be zero. In particular, aimed at resolving the above issues as identified with the above Cases 1-5, it is proposed apparatuses (such as UE, DU, CU, or the like) as well as corresponding methods to address the above-illustrated issues/remarks, particularly in an efficient and flexible manner. Particularly, in a broad sense, it may be seen that the present disclosure generally seeks to propose solutions to shortening the interruption time in LTM handover service, in particular to shortening of the T-search time required for the UE to search a candidate target cell that is not detectable any more at the time of the UE execution of the handover triggered by the gNB or at the time of the gNB triggering a cell change.

The methods proposed by the present disclosure lie in particular in the following aspects.
Aspect 1: Before making an HO decision, insert a timer check (validity check) at the CU. This is aimed at resolving the issue with the above Case 1 where it is indefinitely long as to the time needed by the CU to react on the L3 measurements from the UE. For instance, it is preferably inserted a condition at the CU that for instance steps S304-S310 as shown in FIG. 3 have to be performed within a predetermined period of time, for instance 5-10 seconds, since the CU receives the L3 measurements, or since a time stamp related to the corresponding L3 measurement report. This ensures reduced latency and interruption time in the handover procedure.

In the present disclosure, a time stamp relating to an L1 or L3 report is for instance, a time point when the UE generates the report, or a time point when the UE sends out the report, and etc., which is not limited by the mere examples discussed in the present disclosure for explanation purposes.
Aspect 2: Validity check at the UE side. Namely that the time stamp difference between the current L1 measurement report and the latest L3 measurement report of the same (candidate target) cell is not more than for instance 5 seconds, and with the current measurement values fulling the following “known” or “detactability” conditions. UE shall only return a L1 reportInvalid bit (Invalid Bit) with the latest L1 measurement report (for a candidate target cell) if the measurement (for said candidate target cell) doesn't fulfill the below condition:
   SS-RSRP related side conditions given in NR38.133, clauses 10.1.4 and 10.1.5 for FR1 and FR2, respectively, for a corresponding Band,
   SS-RSRQ related side conditions given in NR38.133, clauses 10.1.9 and 10.1.10 for FR1 and FR2, respectively, for a corresponding Band,
   SS-SINR related side conditions given in NR38.133, clauses 10.1.14 and 10.1.15 for FR1 and FR2, respectively, for a corresponding Band, and
   SSB RP and SSB Ês/lot according to NR38.133, Annex B.2.3 for a corresponding

### Band.

This is aimed at resolving the issue with the above Case 2 and Case 3 where one or more of the candidate target cells previously detected by the UE based on L3 measurements may become unknown due to long periodicity of the L3 measurements. With the configuration of a timer at the UE controlling the time that has passed between the current L1 measurement report and the latest L3 measurement report of the same (candidate target) cell, it can be controlled by the UE that only a predetermined period of time should pass from the last L3 measurement report, such that the impact of the periodicity of the L3 measurements would be reduced. Any cell that is not known any more at the time of the UE performing L1 measurements is preferably indicated with an Invalid bit appended to the L1 measurement report generated by the UE, such that the gNB is informed of invalidity of those cells and could for instance trigger cell change only for cells that are still known.

For instance, for addressing Case 2, it can be provided, following the above step S311 shown in FIG. 3, a step S312a: the UE reports L1 measurements including all detectable cells 1-2 to DU and an L1reportInvalid bit for cell 3.

For instance, for addressing Case 3, it can be provided, following the above step S311 shown in FIG. 3, a step S312b: the UE reports an L1ReportInvalid for all cells, or reports for each of the unknown cells 1-3 a respective Invalid Bit.

Additionally or alternatively, if the DU knows about expiry of e.g., a 5 second timer, the DU can decide handover and send MAC CE within the 5 seconds, which will decrease T_search ideally to zero; time till expiry of the timer may be delivered to the DU by the CU or by the UE.
Aspect 3: Validity check at both the UE side and the gNB side. This is similar to Aspect 2, with the difference being that the timer is moved to the gNB side. Namely that the UE is to check the current L1 measurements values of the candidate target cells to determine if they fulfill the following condition(s). UE shall only return a L1reportInvalid bit with the latest

L1 measurement report if the measurement doesn't fulfill the below condition. Therein, for instace, for addressing Case 2: UE reports L1 measurements including all detectable cells to DU+L1reportInvalid for any undetectable cell(s). Further, for instace, for addressing Case 3: UE reports L1ReportInvalid for all undetectable cells.
SS-RSRP related side conditions given in NR38.133, clauses 10.1.4 and 10.1.5 for FR1 and FR2, respectively, for a corresponding Band,
SS-RSRQ related side conditions given in NR38.133, clauses 10.1.9 and 10.1.10 for FR1 and FR2, respectively, for a corresponding Band,
SS-SINR related side conditions given in NR38.133, clauses 10.1.14 and 10.1.15 for FR1 and FR2, respectively, for a corresponding Band, and
SSB RP and SSB Ês/lot according to NR38.133, Annex B.2.3 for a corresponding Band.

Further, according to Aspect 3: gNB is to check the L1RSRP report received from the UE (invalid/valid as indicated by an Invalid Bit being present or not in the L1 report) and/or the time stamp from the L3 measurement to the current time stamp at the gNB side when the gNB for instance checks validity and before the gNB triggers the cell change. For instance, the gNB shall trigger MAC-CE cell switch within a predetermined period of time since the time stamp related to the L3 measurement reprt, for instance 5 seconds from the L3 measurements.

This is aimed at resolving the issue as identified with the above Case 4 where it takes too long for the gNB to trigger a cell change, during which period of time, previously known candidate target cells become unknown. In this case, it is proposed according to the present disclosure, that the gNB has to trigger the MAC-CE cell switch within a predetermined period of time since the time stamp related to the last L3 report. Therefore, it is preferred according to the present disclosure that the gNB triggers cell change for the candidate target cells that still comply with the detectability or “known” conditions, provided that a predetermined period of time since the time stamp related to the L3 measurements has not expired. This ensures that handover is to be executed by the UE only for valid cells and T_search time is 0 for those valid candidate target cells.

According to Aspect 3, it is preferred that the UE only checks the validity of measurements value, and the gNB checks both the validity of the report (as e.g., indicated by the Invalid Bit) and the timing requirement. Therefore, while the cell is known to the UE by fulfilling only partial requirement conditions related to the measurement values, the gNB checks it further and finds that it may fail the timing requirement at the point when the gNB triggers the serving cell change decision. More preferably, the gNB should also append this failure information to the UE. Generally speaking, if the cell is known to the UE at the time of L1 measurement report, when the gNB checks the timing requirement at the time of decision to trigger cell change, if the timing requirement fails, the gNB should also let the UE knows this information.
Aspect 4: ACK from UE side. If the report in the above options is invalid, UE shall return a MAC-CE ACK to the gNB after MAC-CE cell switch to indicate the estimated T_search and possible T_IU, depending on if RACH-LESS or RACH is proceeded.

Estimated T_Search: For simplicity, UE could return the beam sweeping time for all panels in the initial access. Alternatively, if the report is invalid, it shows that the original candidate cells with the indicated Transmission Configuration Indication (TCI) states are no longer valid. UE could do beam sweep with less available UE beams. The time taken in this case is proportional to the beam sweeping time in the initial access.

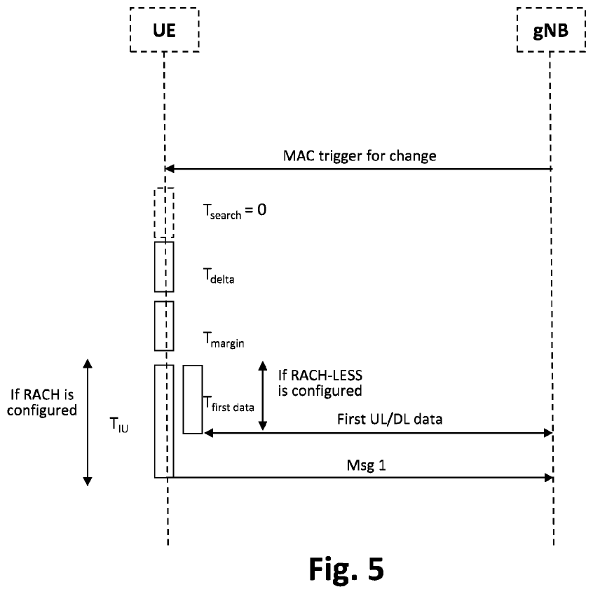

For an estimation of T-IU which as discussed above refers to the interruption uncertainty in acquiring the first available PRACH occasion in the new cell, reference is made to FIG. 5 showing an example of the time related to T-IU in RACH-LESS and RACH cases.

Indicate T_IU: RACH-LESS. For RACH-LESS procedure, the ending point of the service interruption time is the first DL/UL data transmission to the indicated beam of the target cell. T_IU is then the interruption time to the first uplink data transmission to the indicated beam of the target cell as illustrated by the T_first data as shown in FIG. 5.

Indicate T_IU: RACH. For RACH procedure, the ending point of the service interruption time is the transmission of the PRACH message. TIU is then the interruption uncertainty in acquiring the first available PRACH occasion in the new cell.

The uplink resource scheduling information should be contained in MAC-CE trigger for the above both RACH-LESS and RACH cases. The T_IU indication here refers to if UE sees the uplink resources scheduled by gNB possible to make it from UE side, given T_search is now not zero, and UE has to do fine time tracking (T_delta) and SSB post-processing (T_margin). The indication here will be only 1 bit, 0 means negative, and 1 means positive.

In addition, it is provided in accordance with the present disclosure a further aspect aimed at addressing the above issue as identified with Case 5. Namely that the gNB inserts a failure indication to the MAC CE trigger cell change message, so as to indicate to the UE that one or more of the candidate target cells have failed the validity check at the gNB, meaning that the T-search time for those now unknown cells would not be 0 and the UE would have to search those cells. Therefore, the UE is informed in advance of the fact that those candidate target cells would have to be searched.

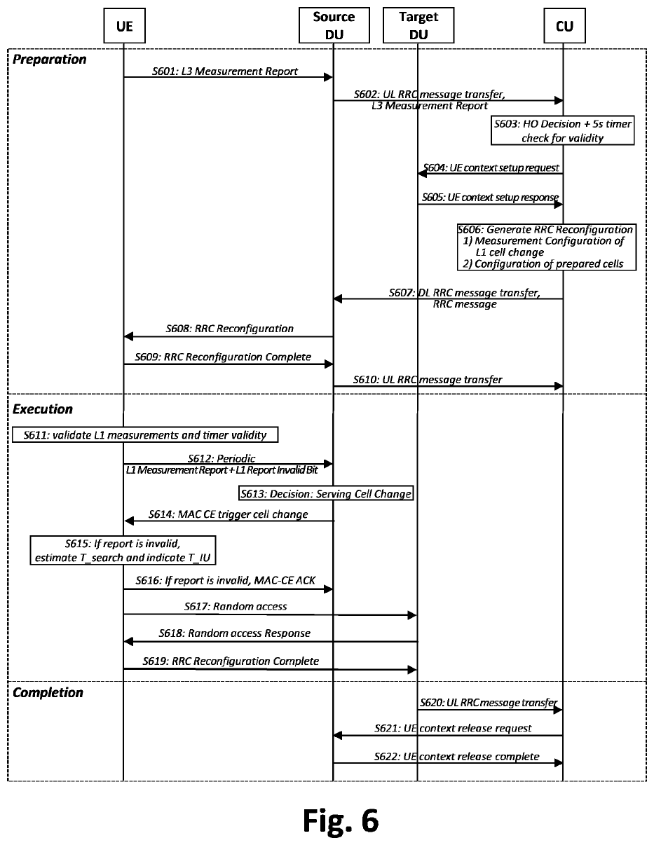

FIG. 6 schematically illustrates an example of validity check at the CU and the UE in an LTM procedure.

In steps S601-S602, the UE sends measurement report containing the cell quality measurements of serving and neighboring cells. The UE can be configured by the serving cell to send measurement report early when it still has a good connection to the serving cell. Using the reported cell quality measurements, the CU can identify a potential set of candidate target cells to which the UE can be handed over to, which may belong to the same DU or different ones—as shown in the current example.

In step S603, the CU decides about the preparation of new cells and checks that the time stamp of this decision is within for instance 5 seconds from the time stamp of the L3 measurement report received.

In step S604, the CU requests the preparation of a candidate target cell(s) controlled by the Target DU by sending a UE Context Setup Request message.

In step S605, the Target DU provides the configuration of the UE in a UE Context Setup Response message containing a container from DU to CU. The same steps S604/S605 are performed with other Target DUs in order to prepare target cell(s).

Having received the UE configurations for the candidate target cell(s), the CU generates an RRC Reconfiguration message that is sent to the UE in step S606. Among other information, the RRC Reconfiguration message contains: Measurement reporting configuration for L1/L2 handover; and Configuration of the prepared candidate cell(s) which the UE needs to execute when it receives a MAC CE command to change the serving cell (perform handover).

In steps S607-S610 the configurations are provided to the UE which also acknowledges the reception and reconfiguration.

In step S611, the UE compares the time stamp of the latest L3 measurements of the same candidate target cell and the current time stamp when the L1 measurement report is being produced. UE also compares the measurement values of the same candidate target cell to check if they fulfil one or more of the conditions as outlined in for instance NR38.133 clause 10.1. If they are valid, and within for instance 5 seconds, UE will not indicate anything to the gNB. This step of verification is for LTM L1 measurements and for addressing Case 2 and Case 3 as discussed in above.

As shown in step S612, the UE starts to report periodically the L1 beam measurement of serving and candidate target cell(s).

Upon determining that there is a target candidate cell having a better radio link/beam measurement than the serving cell (step S613), e.g., L1-RSRP of target beam measurement>L1-RSRP of serving beam measurement+Offset for an amount of time e.g., Time-to-Trigger

(TTT), the serving cell sends a MAC Control Element (MAC CE) or a L1 message in step S614 to trigger the cell change to the target candidate cell.

Step S615: if the L1 report is invalid, the UE estimates possible T_search, and indicates T_IU.

Step S616: the UE will update gNB with MAC-CE ACK after MAC-CE cell switch to indicate the estimated T search time and T_IU.

The handover from serving cell to target cell is executed by the UE in steps S617-S619. Both RACH and RACH-less based cell change are considered as discussed above.

In step S620, the Target DU provides to the CU the RRC Reconfiguration Complete which indicates to the latter that the UE is now served from the target DU.

In steps S621/S622, UE context is released from the source DU.

Further, path switch is performed to the new serving DU (not shown in FIG. 6).

The completion phase is not expected to be impacted in Rel. 18 and is similar to previous NR mobility enhancements of Rel. 16 and 17.

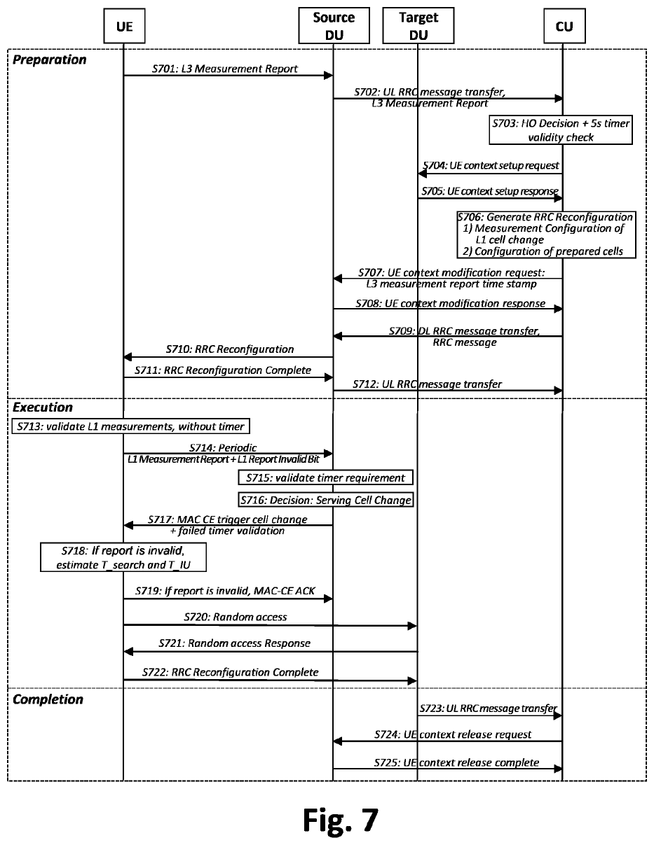

FIG. 7 schematically illustrates an example of validity check at the CU, the DU and the UE in an LTM procedure.

In steps S701-S702, the UE sends measurement report containing the cell quality measurements of serving and neighboring cells. The UE can be configured by the serving cell to send measurement report early when it still has a good connection to the serving cell. Using the reported cell quality measurements, the CU can identify a potential set of candidate target cells to which the UE can be handed over to which may belong to the same DU or different ones—as shown in the current example.

In step S703, the CU decides about the preparation of new cells, and check that the time stamp of this decision is within for instance 5 seconds from the L3 measurement report received and in step S704, the CU requests the preparation of a candidate target cell(s) controlled by Target DU by sending UE Context Setup Request message.

In step S705, the Target DU provides the configuration of the UE in UE Context Setup Response message containing a container from DU to CU. The same steps S704/S705 are performed with other Target DUs in order to prepare target cell(s).

Having received the UE configurations for the candidate target cell(s), the CU generates an RRC Reconfiguration that is sent to the UE in step S706. Among other information, the RRC Reconfiguration message contains: Measurement reporting configuration for L1/L2 handover; and Configuration of the prepared candidate cell(s) which the UE needs to execute when it receives a MAC CE command to change the serving cell (perform handover).

In step S707: the CU includes the L3 measurement report time stamp to CU to DU RRC Information IE in the UE CONTEXT MODIFICATION REQUEST message.

In step S708: the DU responds with UE CONTEXT MODIFICATION RESPONSE message.

In steps S709-S712 the configurations are provided to the UE which also acknowledges the reception and reconfiguration.

In step S713: the UE compares the measurement values of the candidate target cells and checks if they fulfil one or more of the conditions as outlined in for instance NR38.133 clause 10.1 etc. This step of verification is for LTM L1 measurements for addressing Case 2 and Case 3 as discussed in detail above.

As shown in step S714, the UE starts to report periodically the L1 beam measurement of serving and candidate target cell(s).

Step S715: After receiving the L1 measurement reports of various cells according to LTM configuration from UE, gNB is to check if the L1 RSRP report is valid or not, at the same time, it also validates the timing requirement, checking if it is older than for instance 5 seconds from its corresponding L3 measurement report.

Upon determining that there is a target candidate cell having a better radio link/beam measurement than the serving cell (step S716), e.g., L1-RSRP of target beam measurement>L1-RSRP of serving beam measurement+Offset for an amount of time e.g., Time-to-Trigger (TTT), the serving cell sends a MAC Control Element (MAC CE) or a L1 message in step S717 to trigger the cell change to the candidate target cells that have passed validity check. If the timer validity check fails in step S715, gNB will append such indication in MAC-CE to give UE a headup.

Step S718: if the L1 report is invalid or timer fails, UE estimates T_search and indicate T_IU.

Step S719: if the L1 report is invalid or timer fails, UE will update gNB with MAC-CE ACK after MAC-CE cell switch to indicate the estimated T_search time and/or T_IU time.

The handover from serving cell to target cell is executed by the UE in steps S720-S722. Both RACH and RACH-less based cell change are considered as discussed above.

In step S723, the Target DU provides to the CU the RRC Reconfiguration Complete which indicates to the latter that the UE is now served from the target DU.

In steps S724/S725, UE context is released from the source DU.

Path switch is performed to the new serving DU (not shown in FIG. 7).

The completion phase is not expected to be impacted in Rel. 18 similar to previous NR mobility enhancements of Rel. 16 and 17.

To summarize the above, the example embodiment as described above with reference to FIGS. 6 and 7 may generally be seen as to propose to include in the conventional LTM procedure validity check at the CU, and/or at the Source DU, and/or at the UE for improving efficiency in preparation and execution of handover for LTM.

More specifically, it is proposed to perform validity check by determining whether measurement values provided by the UE, preferably via L1 measurements, of selected candidate target cells (as selected on the basis of L3 measurements performed by the UE) would fulfill preset conditions. The preset conditions are used for determining whether said selected candidate target cells are known or detectable at the UE, which may include conditions as indicated in NR38.133, clauses 10.1.4 and 10.1.5 for FR1 and FR2, respectively; NR38.133, clauses 10.1.9 and 10.1.10 for FR1 and FR2, respectively; NR38.133, clauses 10.1.14 and 10.1.15 for FR1 and FR2, respectively; and Annex B.2.3. This is of course merely for explanation purposes, which shall not be construed as being limiting on the scope of the present disclosure.

Following such a detectability check at the UE, the UE preferably provides to the gNB an L1 measurement report with measurements for those candidate target cells that are determined as being detectable at the UE, and more preferably, the UE adds to the L1 measurement report an Invalid Bit for any candidate target cell that is not known or detectable any more due to for instance the long periodicity of the L3 measurements.

Further, in addition to the validity check concerning the detectability conditions of the L1 measurement values of the selected candidate target cells, the UE preferably checks whether a predetermined time (e.g., 5 seconds) has passed since a time stamp related to the latest L3 measurement report (e.g., generation of such an L3 measurement report and etc.). It is preferable that the UE provides to the gNB an L1 measurement report with measurements for those candidate target cells that are determined as being detectable at the UE, provided that the predetermined time has not yet expired. Therefore, it is ensured that validity or invalidity of the candidate target cells are being tracked by the UE within the predetermined time since the time stamp of the latest L3 measurement report. For any invalid cells (L1 measurement values not complying with the preset conditions and/or the predetermined time has expired), the UE preferably appends an Invalid Bit to the L1 measurement report, and the gNB accordingly receives such an indication informing the gNB of which cells are still known and which not any more.

Additionally or alternatively, the gNB preferably also checks whether a predetermined time (e.g., 5 seconds) has passed since the time stamp of the latest L3 measurements, or since the gNB receives those L3 measurements for instance. Namely that the gNB, in addition to checking whether an Invalid Bit for any one of the candidate target cells is present in the L1 measurement report received from the UE, further checks whether the predetermined time has expired at the time of the gNB deciding to trigger a cell change to said any one of the candidate target cells. In other words, the gNB is preferably configured to trigger cell change only for cells that are still detectable, provided that the predetermined time has not passed since the time stamp of the latest L3 measurements. More preferably, the gNB informs the UE of any failure at validity check. This ensures that the gNB keeps track of (possibly any change in) validity of the candidate target cells indicated with the L1 measurement report received from the UE within the predetermined time. As a result, the T-search time is ensured to be set to 0 for those cells that are still detectable within the predetermined time set at the gNB since for instance the time stamp of the L3 measurement report.

For cells that do not fulfill the detectability conditions where the timer has expired, the T_search time and the T_IU time are preferably indicated by the UE such that the gNB is informed of possible interruption time in the handover procedure, leading to improved certainty.

In addition, it is proposed according to the present disclosure preferably to include a validity check at the CU before making an HO decision, namely that the CU is configured to perform preparation of candidate target cells for HO within a predetermined time (e.g., 5 seconds). This leads to shortened delay in the HO procedure.

With the above methods proposed by the present disclosure, it can be seen that the impact of the long periodicity of the L3 measurements on the certainty of the validity state of the candidate target cells (selected on the basis of the L3 measurements) is reduced. It is further ensured that, for any candidate target cells that are detectable at the time of the gNB triggering a corresponding cell change and/or at the time of the UE excecuting such a cell change, the T_search time is set to be 0, whereas the UE and/or the gNB is keeping track of any possible delay induced by candidate target cells being not known or detectable any more. As a result, the interruption time in LTM handover is reduced with improved certainty and reliability. As has been noted above, although in the above-illustrated example embodiments

(with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-39. (canceled)

40. A user equipment, UE, configured to connect to a source cell of a first network node that supports distributed unit, DU, functionality and/or a layer 2 protocol processing of a radio access network, RAN, the UE comprising:
at least one processor; and
at least one memory storing instructions that, when executed by the at least one processor, cause the UE at least to:
generate L1 measurements for at least one of a plurality of candidate target cells controlled by the first network node or another network node, wherein said plurality of candidate target cells are selected based on L3 measurements generated by the UE;
determine if said at least one of the plurality of candidate target cells complies with one or more preset conditions for the UE to enable executing handover from a serving source cell to at least one of said plurality of candidate target cells for L1L2-triggered mobility, LTM; and
transmit, preferably periodically, a L1 measurement report to the first network node,
wherein said L1 measurement report is provided by the UE based on said determination relating to said one or more preset conditions,
wherein said one or more preset conditions comprise:
that Synchronization Signal/PBCH Blocks, SSBs, of at least one of said plurality of candidate target cells are detectable, and/or
that a first timer has not expired since a first time point indicated by a first timestamp related to a L3 measurement report comprising said L3 measurements, and the UE is further caused to: at a second time point indicated by a second timestamp related to said L1 measurement report, determine if said first timer has expired, wherein said L3 measurement report is the latest L3 measurement report generated by the UE at the time of preparing said L1 measurement report.

41. The UE according to claim 40, wherein said L1 measurement report comprises L1 measurements for one or more of said plurality of candidate target cells that are determined as complying with said one or more preset conditions.

42. The UE according to claim 40, wherein the UE is further caused to:
append an Invalid bit to said L1 measurement report for any one of said plurality of candidate target cells that is determined as not complying with said one or more preset conditions; and
transmit, preferably periodically, said L1 measurement report with said appended Invalid bit to the first network node.

43. The UE according to claim 40, wherein a length of said first timer is 5 seconds.

44. The UE according to claim 40, wherein the UE is further configured to determine whether SSBs of said plurality of candidate target cells are detectable based on at least one of: Synchronization Signal Reference Signal Received Power, SS-RSRP, CSI Reference Signal Received Power, CSI-RSRP, Synchronization Signal Reference Signal Received Quality, SS-RSRQ, CSI Reference Signal Received Quality, CSI-RSRQ, Synchronization Signal Signal to Interference and Noise Ratio, SS-SINR, CSI Signal to Interference and Noise Ratio, CSI-SINR.

45. The UE according to claim 40, wherein the UE is further caused to:
after receiving from the first network node a cell change trigger message, transmit a cell change trigger response message to the first network node if it is determined that any one of said plurality of candidate target cells that is determined as not complying with said one or more preset conditions.

46. The UE according to claim 45, wherein the UE is further caused to:
in said cell change trigger response message, include T-Search information indicating a first estimated time required for searching any one of said plurality of candidate target cells that is determined as not complying with said one or more preset conditions.

47. The UE according to claim 45, wherein the UE is further caused to:
in said cell change trigger response message, include T-IU information indicating a second estimated time for Interruption Uncertainty in acquiring the first available Physical Random Access Channel, PRACH, occasion in any one of said plurality of candidate target cells that is determined as not complying with said one or more preset conditions, wherein preferably said second estimated time is determined based on whether a Random Access Channel, RACH or RACH-less procedure is applied by the UE.

48. The UE according to claim 45, wherein said cell change trigger response message is transmitted via lower layer signaling.

49. A first network node, being configured to support distributed unit, DU, functionality and/or a layer 2 protocol processing of a radio access network, RAN, said first network node comprising:
at least one processor; and
at least one memory storing instructions that, when executed by the at least one processor, cause the first network node at least to:
determine if at least one of a plurality of candidate target cells controlled by the first network node complies with one or more preset conditions for a UE to execute handover from a serving source cell of the first network node to at least one of said plurality of candidate target cells for L1L2-triggered mobility, LTM, wherein said determination is carried out by the first network node based on L1 measurements and/or L3 measurements provided by the UE for said plurality of candidate target cells; and
transmit a cell change trigger message to the UE based on said determination, wherein said cell change trigger message comprises indications for triggering change to one or more of said candidate target cells that are determined as complying with said one or more preset conditions.

50. The first network node according to claim 49, wherein the first network node is further configured to:
for each of said one or more candidate target cells, determine whether said each candidate target cell complies with said one or more preset conditions, wherein said one or more preset conditions comprise that, for said each candidate target cell, an L1 measurement report comprising said L1 measurements received from the UE does not comprise an Invalid bit.

51. The first network node according to claim 49, wherein the first network node is further configured to:
for each of said one or more candidate target cells, determine whether said each candidate target cell complies with said one or more preset conditions, wherein said one or more preset conditions comprise that, for said each candidate target cell, a second timer has not expired since a first time point indicated by a first timestamp related to an L3 measurement report comprising said L3 measurements received from the UE, wherein the first network node is further caused to:
at a third time point, determine if said second timer has expired, wherein said third time point is after receiving from the UE an L1 measurement report comprising said L1 measurements and before transmitting said cell change trigger message to the UE, wherein said L3 measurement report is the latest L3 measurement report generated by the UE at the time of preparing said L1 measure report.

52. The first network node according to claim 51, where the first network node is further caused to transmit said cell change trigger message before said second timer expires.

53. The first network node according to claim 51, wherein a length of said second timer is 5 seconds.

54. The first network node according to claim 49, wherein the first network node is further caused to: include a failure indication in said cell change trigger message for any one of said plurality of candidate target cells that is determined as not complying with said one or more preset conditions.

55. The first network node according to claim 49, wherein said cell change trigger message is transmitted via lower layer signaling, and is preferably MAC Control Element, MAC CE, or Downlink Control Information, DCI.

56. A second network node, being configured to support central unit, CU,
functionality and/or a layer 3 protocol of a radio access network, RAN, comprising:
at least one processor; and
at least one memory storing instructions that, when executed by the at least one processor, cause the second network node at least to:
determine a first timestamp related to an L3 measurement report that is received from a UE, said UE being served by a source cell of a first network node, said L3 measurement report comprises L3 measurements for a plurality of candidate target cells controlled by said first network node;
include said first timestamp in CU to DU Information to be transmitted to said first network node; and
transmit said CU to DU Information with included first timestamp to said first network node.

57. The second network node according to claim 56, wherein the second network node is further caused to transmit said CU to DU Information in a UE context modification request message.

58. The second network node according to claim 56, wherein the second network node is further caused to:
before a third timer expires, decide to perform preparation of said plurality of candidate target cells for the UE to execute handover from said serving source cell to at least one of said plurality of candidate target cells for L1L2-triggered mobility, LTM, wherein said third timer starts at a fourth time point of receiving said L3 measurement report from the UE.

59. The second network node according to claim 58, wherein said performing preparation of said plurality of candidate target cells comprises one or more of: transmitting a UE context setup request message to said first network node, generating and transmitting to said first network node RRC reconfigurations related to said plurality of candidate target cells, and transmitting a UE context modification request message to said first network node.

60. The second network node according to claim 58, wherein a length of said third timer is 5 seconds.
